(19) United States
(12) Patent Application Publication
(10) Pub. No.: US 2025/0300994 A1
(43) Pub. Date: Sep. 25, 2025

(54) SYSTEMS AND METHODS FOR ANTI-FRAUD MESSAGE INSPECTION

(71) Applicant: OPEN TEXT HOLDINGS, INC., Menlo Park, CA (US)

(72) Inventors: Kathleen L. Achilles, Forked River, NJ (US); Amitava Dutta, Plainsboro, NJ (US)

(21) Appl. No.: 18/613,572

(22) Filed: Mar. 22, 2024

(51) Int. Cl. H04L 9/40

(52) U.S. Cl. CPC H04L 63/1408

(57) ABSTRACT

Disclosed is an anti-fraud message inspection solution that can provide an additional level of protection after incoming messages have been examined, at ingress, by enterprise protection mechanisms (e.g., firewalls, routers, gateways, etc. with virus scanning software) and before the messages arrive in application processing queues. The anti-fraud message inspection solution includes a message inspector downstream from the enterprise protection mechanisms. The message inspector receives an email that has passed a filtering mechanism at ingress, performs a plurality of checks on the email utilizing local database files, and places the email in a suspect queue or an application processing queue depending upon whether the email fails any of the plurality of checks or passes all the plurality of checks.

### TECHNICAL FIELD

This disclosure relates generally to message processing in a networked environment. More particularly, this disclosure relates to systems, methods, and computer program products for anti-fraud message inspection.

### BACKGROUND OF THE RELATED ART

Today, malicious actors send high volume electronic messages that consume a huge amount of system resources, that may impact timely delivery of legitimate messages, and that may also incur unnecessary telecommunication charges. There is a continuing need to inspect messages against malicious activities with minimal to zero impact on legitimate messages.

In some cases, however, a legitimate user may start to send a large amount of messages. This is harder to detect as a malicious behavior as the user was previously determined as a legitimate one. For instance, a fraudster may somehow pass a check and initially be determined as a legitimate user. Later, the fraudster may then freely send very high-volume spam messages to be delivered to many countries around the world. As another example, a fraudster may somehow get a valid sender address and then use third-party servers to send high volume spam messages.

### SUMMARY OF THE DISCLOSURE

A goal of this disclosure is to provide a message inspection tool that resides between an application and an enterprise mail server and that can provide an enhanced inspection of electronic mail messages (e.g., emails, hereinafter collectively referred to as messages) after they passed the Sender Policy Framework (SPF) check and appear to have come from legitimate user(s) and before these messages are processed into faxes for fax delivery. SPF is a known email authentication method and thus is not further described herein.

Because these messages are destined for fax delivery, each one has a fax (phone) number as the destination. In embodiments disclosed herein, this destination can be a string. The inspection tool is operable to process this string and perform string parsing, conversion, and analysis. The string parsing operation can reveal a destination country code from the string. An analysis of the destination country code against a known set of destination countries may determine whether a message from a particular domain can be delivered.

For example, enterprise A (e.g., Domain A) may be sending messages to USA and Japan, and enterprise B (e.g., Domain B) may be sending messages to 30 different countries, but only to those 30 countries etc. If an analysis reveals that messages from Domain A and Domain B are now destined for delivery to countries that they do not normally send, then those messages could be suspected as fraudulent and placed in a queue for quarantine (e.g., sandboxing).

Normally, if messages fail the SPF check, then they are quarantined. In some cases, however, the SPF configuration could be incorrect or incomplete. In such cases, exceptions can be defined so that some messages that failed the SPF check can still be processed. Such exceptions can be defined on a per-enterprise or per-domain basis. For instance, a ‘Received’ header of an incoming message will be inspected for Internet Protocol (IP) addresses. If any of the IP addresses matches any black listed IP addresses, then the message will be quarantined. If any of the IP addresses matches any whitelisted IP addresses, then the message is processed.

In embodiments disclosed herein, an anti-fraud message inspection solution can provide an additional level of protection after incoming messages have been examined, at ingress, by enterprise protection mechanisms (e.g., firewalls, routers, gateways, access points, switches, etc. with fraud detection filter(s), spam filter(s), virus scanning software, etc.) and before the messages arrive in application processing queues.

In some embodiments, the anti-fraud message inspection solution can include a message inspection tool or a message inspector downstream from the enterprise protection mechanisms. For example, when the message inspector receives an email that has passed a filtering mechanism at ingress, the message inspector performs a plurality of checks on the email utilizing local database files and places the email in a suspect queue or an application processing queue depending upon whether the email fails any of the plurality of checks or passes all the plurality of checks.

In some embodiments, the message inspector may receive an email that has passed a filtering mechanism at ingress of an enterprise computer network. Utilizing local database files stored in a database, the message inspector may perform a plurality of checks on the email. Responsive to the email failing any of the plurality of checks, the message inspector may place the email in a suspect queue. Responsive to the email passing the plurality of checks, the message inspector may place the email in an application processing queue.

In some embodiments, the local database files may comprise at least two of a Sender Policy Framework (SPF) rule, a blacklist, a whitelist, a destination file, a country code limit configuration file, a usage limit configuration file, or a job rate limit configuration file.

In some embodiments, the plurality of checks may comprise at least two of an Internet Protocol (IP) check, a Sender Policy Framework (SPF) failure check, a destination check, a volume check, a country code limit check, a usage limit check, or a job rate limit check. In some embodiments, the country code limit check involves checking a country code limit associated with the email. In some embodiments, the usage limit check involves checking a usage limit for a sender address or originating domain of the email. In some embodiments, the job rate limit check involves checking a job rate limit that specifies a number of messages that can be submitted by a domain, a single user, or a single user in a domain in a timeframe.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatic representation of an example of a message processing architecture.

FIG. 2 depicts a diagrammatic representation of an example of a message processing architecture with a message inspection tool according to some embodiments disclosed herein.

FIG. 3 depicts a diagrammatic representation of fraud/spam filtering at the message ingress server stage and at the application server stage.

FIG. 4 depicts a diagrammatic representation of a message inspection tool that provides an application-level fraud detection according to some embodiments disclosed herein.

FIG. 5 depicts a diagrammatic representation of an example of a message inspection tool in operation according to some embodiments disclosed herein.

FIG. 6 depicts a diagrammatic representation of an example of distributed network computing environment where embodiments disclosed herein can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

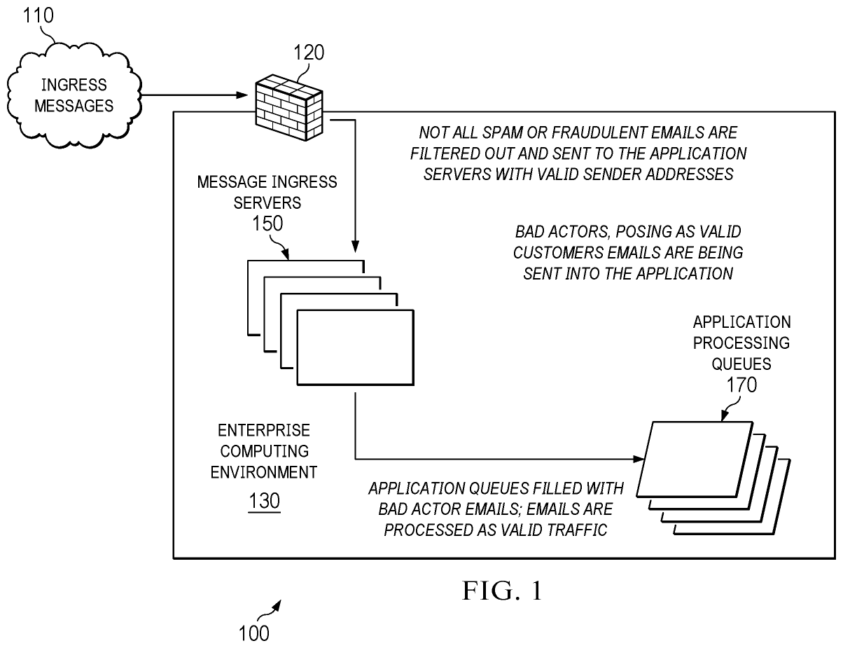

Using the Simple Mail Transfer Protocol (SMTP) envelope address or custom SMTP header addresses to validate a sender of a message can be effective, since information contained therein is not easy to fake. In recent times, some malicious actors have started sending very high-volume spam messages to be delivered to many countries around the world. It appears that these malicious actors somehow get to know valid sender address from various customers and then use third-party servers to send high volume spam messages with valid sender address to mask their attacks. This is shown in FIG. 1.

FIG. 1 depicts an example of the current message processing architecture 100 in which spam or fraudulent messages with valid sender address (e.g., “ingress messages 110”) arriving at a networked computing environment (e.g., an enterprise computer network 130) may not all be caught and filtered out by existing message inspection solutions (e.g., virus scan software running on a firewall or gateway device 120 and/or fraud/spam filters running on message ingress servers 150). For instance, a spam or fraudulent message may have a sender address that is not found on a blacklist and/or that matches a whitelisted IP address. Such a spam or fraudulent message could then be sent to an application server(s) with a presumed valid sender address for further processing (e.g., being placed in application processing queues 170). This means that spam or fraudulent messages from bad actors, posing as valid customer messages, can actually pass through existing message inspection mechanisms and into user application(s).

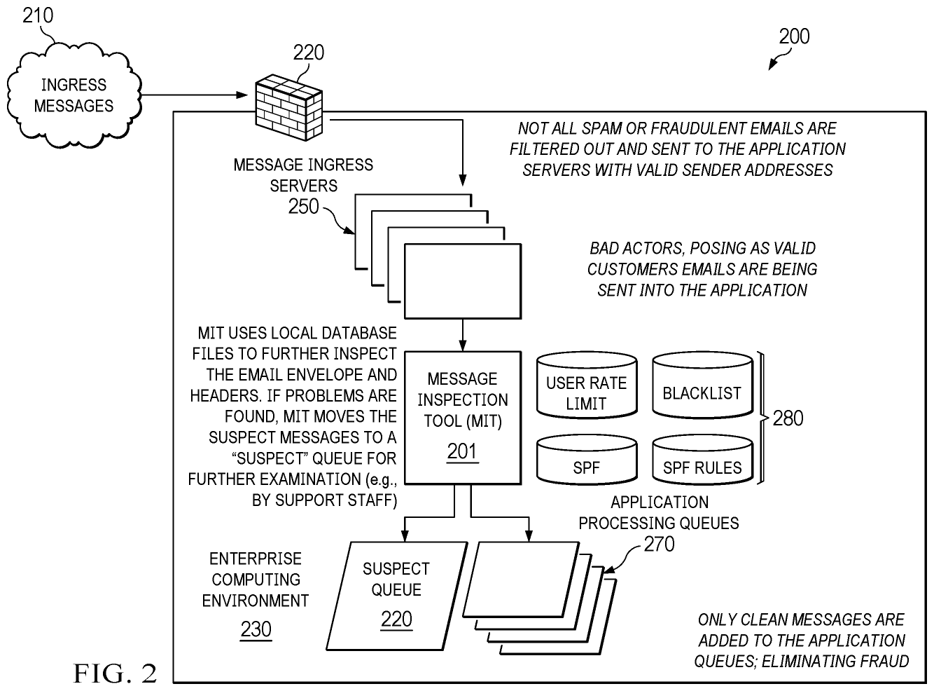

FIG. 2 depicts a diagrammatic representation of an example of a message processing architecture 200 with a message inspection tool (MIT) 201 according to some embodiments disclosed herein. The message processing architecture 200 includes an enterprise computing environment 230 with a firewall or gateway device 220 and message ingress servers 250 configured for processing ingress messages 210 using existing message inspection mechanism(s) as discussed above.

As illustrated in FIG. 2, some spam or fraudulent messages with valid sender addresses may not be filtered out by the firewall or gateway device 220 and/or the message ingress servers 250, allowing them to pass through existing message inspection mechanisms. To address this “leak” issue, the MIT 201 can further inspect incoming messages (e.g., SMTP envelope and headers), using rules (e.g., SPF rules), lists (e.g., blacklist, whitelist, etc.), configuration files (e.g., for setting a user rate limit, configuring a SPF check, etc.), and so on stored in local database(s) 280 (which are collectively referred to herein as local database files) to limit the number of messages that can be submitted by a domain, a single user, or a single user in a domain in a timeframe, per job rate, and/or per destination country.

In this way, the MIT 201 can help to reduce or eliminate the number of spam or fraudulent messages with presumed valid sender addresses being placed in application processing queues 270 for further processing. In the example of FIG. 2, local database files can include those that specify a user job rate limit, a blacklist, a SPF check, a SPF rule, etc. Other message inspection files can also be stored in a database local to the MIT 201 so that they can be utilized by the MIT 201.

As discussed above, generally, processing of incoming messages is first performed at a message ingress server configured with conventional fraud filters such as Sendmail milters (mail filter), SPF, DKIM (Domain Key Identified Mail), and DMARC (Domain-based Message Authentication, Reporting and Conformance, etc. These fraud filters are known to those skill in the art and thus are not further described herein. Messages that passed through these fraud filters are then passed to an application server, which may also use conventional fraud filters. However, if and when valid customer credentials are compromised and used to send messages, the application server will not be able to detect such messages, resulting in fraud at the application level.

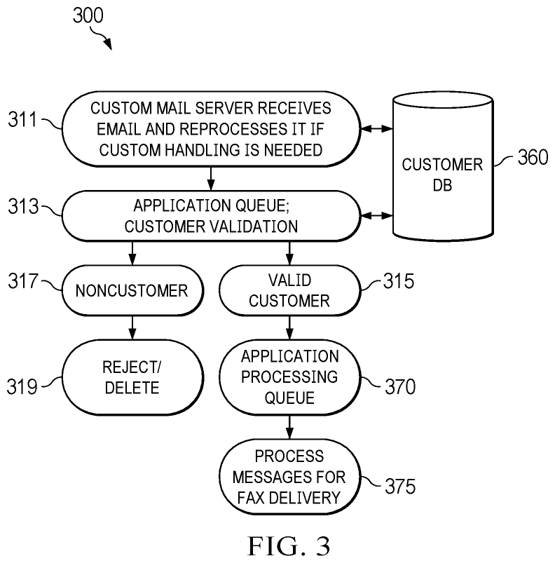

As a non-limiting example, FIG. 3 shows an example of a method 300 for processing an email message for fax delivery. In this example, a mail server which resides in an enterprise computing environment protected by a networking device such as a firewall or gateway device, may receive an email at ingress as discussed above (311).

Based on a customer setting stored in a database 360, the mail server may reprocess the email to determine if custom handling (e.g., customer validation) is necessary. If so, the mail server may place the email in an application queue and uses information (e.g., a sender address) stored in the database 360 to validate the email (313). If a spam or fraudulent email was sent with a valid sender address, the mail server will, albeit unknowingly, determine that the spam or fraudulent email was sent by a valid customer based on the valid sender address (315) and proceed to place the email in an application processing queue for further processing (370), for instance, for fax delivery (375). If the mail server determines that the email was sent by a non-customer (317), then the mail server will proceed to reject or delete the email (319).

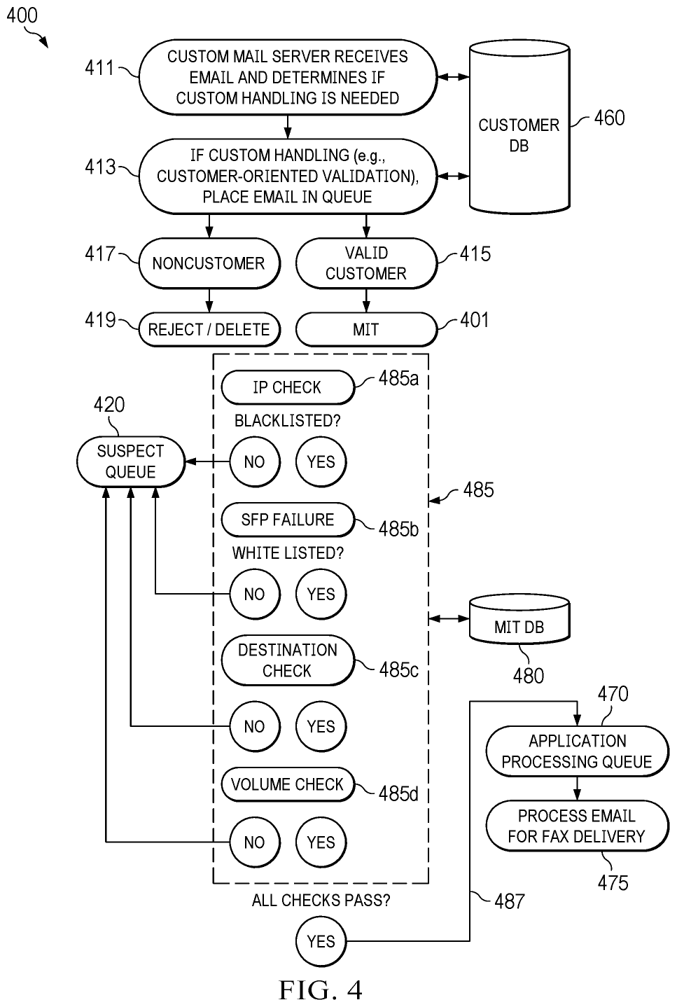

FIG. 4 is a flow diagram that illustrates an example of a method 400 for message inspection with an application-level fraud detection according to some embodiments disclosed herein. Similar to the example described above with reference to FIG. 3, a mail server residing in an enterprise computing environment protected by a firewall or gateway device may receive an email at ingress (411). Based on a customer setting or configuration stored in a database 460, the mail server may process the email to determine if custom handling (e.g., customer-oriented validation) is necessary. If so, the mail server may place the email in an email-to-fax queue and use information (e.g., a sender address) stored in the database 460 to validate the email (413). If the mail server determines that the email was sent by a valid customer, then the mail server will provide the email and the valid sender address to an MIT 401 (415). However, if the mail server determines that the email was sent by a non-customer (417), then the mail server will proceed to reject or delete the email (419).

In some embodiments, the MIT 401 may perform a plurality of checks 485 using local database files stored in an MIT database 480. As illustrated in FIG. 4, through the plurality of checks 485, the MIT 401 provides an application-level stage to facilitate identifying fraud in messages that passed through (i.e., if and when valid customer credentials are compromised and used to submit the messages) existing fraud/spam filters operated at ingress (e.g., message ingress server(s) 250 shown in FIG. 2).

In some embodiments, the plurality of checks 485 may include an Internet Protocol (IP) check (485a), which involves checking the IP address of a sender contained in the SMTP envelop or header of the email and determining whether the IP address is blacklisted or whitelisted. If it is determined that the IP address is blacklisted, the email is placed in a suspect queue 420 (e.g., for an automated or manual review). The plurality of checks 485 may also include an SPF failure check (485b), which involves checking, if the email fails the SPF check, whether the email is whitelisted. If the email that failed the SPF check is not whitelisted, the email is placed in the suspect queue 420. The plurality of checks 485 may further include a destination check (485c), which involves checking whether the destination of the email is specified in one of the local database files stored in the MIT database 480. If the destination of the email is not specified in any of the local database files stored in the MIT database 480, the email is placed in the suspect queue 420. Moreover, the plurality of checks 485 may include a volume check (485d), which involves checking whether the volume of messages (i.e., a quantity of messages received over a window of time or timeframe) from a domain where the email under examination originated exceeds a predefined threshold. If so, the email is placed in the suspect queue 420. The plurality of checks 485 may include one or more additional checks such as those for checking a country code limit associated with the email, a usage limit for the sender's email address or the originating domain of the email, or a job rate limit that limits the number of messages that can be submitted by a domain, a single user, or a single user in a domain in a timeframe.

If the email passed the plurality of checks 485, the MIT 401 allows the message to proceed (487), and places the email in an application processing queue 470 and the email can then be processed for fax delivery (475).

In some embodiments, the MIT can be configured with a system wide default for all users not specifically defined by domain or single user entry. A non-limiting example of a timeframe is 5-minute intervals. The number of domains and user job rates are configurable and may vary from implementation to implementation, depending on historical traffic patterns for all users of an enterprise computing environment where the message inspection tool resides and operates. In some embodiments, the message inspection tool can be configured with country code limitations so as to limit the number of messages that can be sent from the enterprise computing environment to a list of specified countries, with individual limits for different countries. This “per country code” limit can be further specified within a timeframe and/or combined with other message inspection parameters.

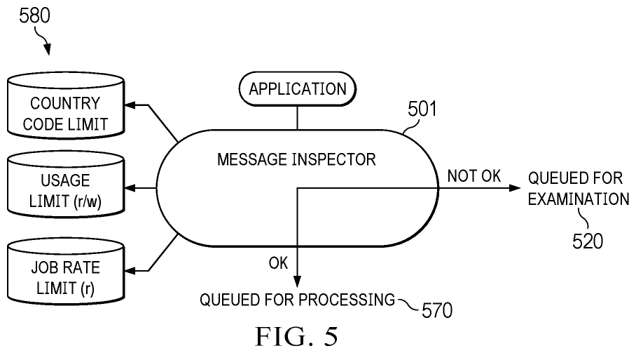

FIG. 5 depicts a diagrammatic representation of an example of a message inspection tool (a “message inspector”) 501 in operation according to some embodiments disclosed herein. As illustrated in FIG. 5, the message inspector 501 can detect and quarantine malicious spam messages, after such messages have been examined by enterprise protection mechanisms (e.g., firewalls, routers, gateways, access point, switch, etc. with virus scanning software) and before the messages arrive in the application processing queues. This provides an additional level of protection (at the application level) and can be adjusted to a particular application user's normal usage in view of country code limit, job rate limit (r), usage limit (r/w), destination limit, IP sourcing, etc., as defined in local database files 580. It also provides a blacklist method where IP addressed can be blocked at the application level, allowing for a faster, more targeted layer of protection in an enterprise computing environment. Non-limiting example checks are described in detail below.

### Job Rate Limit

Most legitimate customers send messages at a pre-determined rate, depending on their own internal network and procedures. For example, Enterprise-A may usually be sending around 100 messages per hour, while Enterprise-B may often send 500 messages in 10 minutes. Each enterprise's traffic data can be analyzed for a prior period of time (e.g., the previous 12 months) and, based on the usage pattern determined from the traffic data analysis, the usual job rate can be determined for individual enterprises.

Then, a customized job rate limit can be introduced and used by the message inspector. This customized job rate limit is what each enterprise is assigned based on their usage pattern of the prior time period. If the message inspector finds an unexpected surge in volume of any enterprise, then those messages will be quarantined, and support staff will be prompted to review the quarantined messages. If the messages are valid, support staff may increase the allowed job rate limit for that sender and re-submit the messages for processing. As a non-limiting example, the job rate counts can be refreshed every 5 minutes.

In the example of FIG. 5, if a job rate is okay (e.g., the job rate limit has not been met), the message inspector returns “PROC,” which means that the message will remain in an application queue for application processing (570). If the message inspector determines that the job rate is not okay (i.e., the job rate limit has been met), the message inspector returns “BLOK” and sends to a suspect queue for examination (520). If the examination reveals that the traffic is valid, the user's job rate can be adjusted and the messages can be moved back to the main queue for normal processing (570).

### Country Code Limit

Most enterprises send messages to only a known set of destination countries. For example, Enterprise-A may be sending messages to USA and Japan, while Enterprise-B may be sending messages to 30 different countries, but only to those 30 countries etc. If the message inspector finds one of those enterprises is sending messages to countries that they do not normally send, then those messages could be suspected fraud and the message inspector would quarantine those messages.

As a non-limiting example, to set a domain's destination limits, the following command may be used:
add domain.com -ccode JP, US, 1343
where “domain.com” is the subject domain, “-ccode” is the option for a calling code list, and “JP, US, 1343” is a list of single or mixed “alpha2” codes and/or calling codes from the Country-ISO_and-Calling_Code chart. In this example, the command is set to allow fax calls from the domain to JP (Japan), US, and Canada Ottawa, ON. Note that because 1343 is on the list rather than CA, the only Canadian numbers allowed for this domain are to Ottawa and only the 343 area code.

### SPF Validation Check

Some enterprises, often small and medium businesses, have incorrect or incomplete SPF configuration. To process their messages, specific exceptions would need to be allowed on a per-enterprise basis. If messages fail this secondary SPF check performed by the message inspector, then those messages will be quarantined. Optionally, the secondary SPF check can be turned off for a domain (by modifying a corresponding local database file).

### Blacklist IP Address Check

The message inspector is operable to inspect the header of an incoming message for IP addresses. If any IP address is found to match any black listed IP address, then those messages with the IP address will be quarantined so that the messages can be verified by operations staff. Specific IP addresses may be whitelisted on per-enterprise basis.

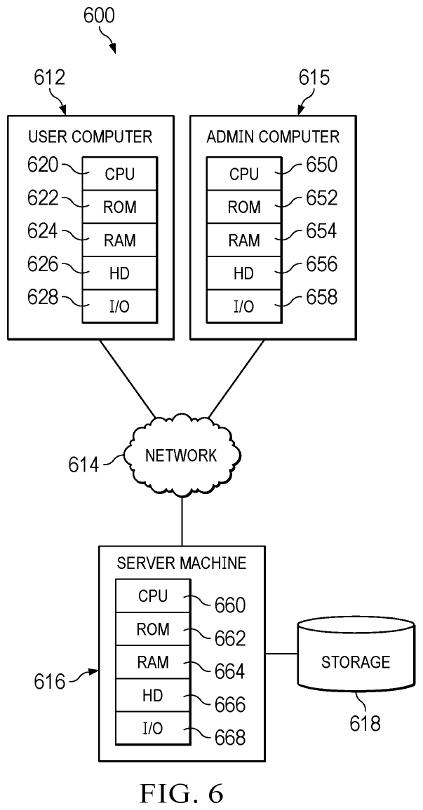

FIG. 6 depicts a diagrammatic representation of an example of distributed network computing environment where embodiments disclosed herein can be implemented. In the example illustrated, network environment 600 includes network 614 that can be bi-directionally coupled to user device 612 (e.g., for a sender or receiver), administrator computer 615 (e.g., for configuring a message inspection tool and/or local database files), and server computer 616 (e.g., for running an MIT or message inspector). Server computer 616 can be bi-directionally coupled to database 618. Database 618 may store local database files used by the MIT or message inspector to perform application-level checks as described above. Network 614 may represent a combination of wired and wireless networks that network computing environment 600 may utilize for various types of network communications known to those skilled in the art.

For the purpose of illustration, a single system is shown for each user device 612, administrator computer 615, and server computer 616. However, within each of user device 612, administrator computer 615, and server computer 616, a plurality of networked devices and computers alike (not shown) may be interconnected to each other over network 614. For example, a plurality of user devices 612, a plurality of server computers 616, and a plurality of administrator computers 615 may be coupled to network 614.

User device 612 can include central processing unit (“CPU”) 620, read-only memory (“ROM”) 622, random access memory (“RAM”) 624, hard drive (“HD”) or storage memory 626, and input/output device(s) (“I/O”) 628. I/O 628 can include a keyboard, monitor, printer, electronic pointing device (e.g., mouse, trackball, stylus, etc.), or the like. User device 612 can include a desktop computer, a laptop computer, a personal digital assistant, a cellular phone, or nearly any network-enabled device capable of communicating over a network. Administrator computer 615 may be similar to user computer 612 and can comprise CPU 650, ROM 652, RAM 654, HD 656, and I/O 658. Likewise, server computer 616 may include CPU 660, ROM 662, RAM 664, HD 666, and I/O 668. Many other alternative configurations are possible and known to skilled artisans.

Each of the computers in FIG. 6 may have more than one CPU, ROM, RAM, HD, I/O, or other hardware components. For the sake of brevity, each computer is illustrated as having one of each of the hardware components, even if more than one is used. Each of computers 612, 615, and 616 is an example of a data processing system. ROM 622, 652, and 662; RAM 624, 654, and 664; HD 626, 656, and 666; and data store 618 can include media that can be read by CPU 620, 650, or 660. Therefore, these types of memories include non-transitory computer-readable storage media. These memories may be internal or external to computers 612, 615, or 616.

Portions of the methods described herein may be implemented in suitable software code that may reside within ROM 622, 652, or 662; RAM 624, 654, or 664; or HD 626, 656, or 666. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the invention should be determined by the following claims and their legal equivalents.

What is claimed is:

1. An anti-fraud message inspection method, comprising:
receiving, by a message inspector operating on a server machine in an enterprise computer network, an email that has passed a filtering mechanism at ingress of the enterprise computer network;
performing, by the message inspector utilizing local database files, a plurality of checks on the email, the local database files stored in a database communicatively connected to the message inspector;
responsive to the email failing any of the plurality of checks, placing, by the message inspector, the email in a suspect queue; and
responsive to the email passing the plurality of checks, placing, by the message inspector, the email in an application processing queue.

2. The method according to claim 1, wherein the filtering mechanism comprises a fraud detection filter, a spam detection filter, or virus scanning software running on a networking device and wherein the networking device comprises at least one of a firewall, router, gateway, access point, or switch.

3. The method according to claim 1, wherein the local database files comprise at least two of a Sender Policy Framework (SPF) rule, a blacklist, a whitelist, a destination file, a country code limit configuration file, a usage limit configuration file, or a job rate limit configuration file.

4. The method according to claim 1, wherein the plurality of checks comprises at least two of an Internet Protocol (IP) check, a Sender Policy Framework (SPF) failure check, a destination check, a volume check, a country code limit check, a usage limit check, or a job rate limit check.

5. The method according to claim 4, wherein the country code limit check involves checking a country code limit associated with the email.

6. The method according to claim 4, wherein the usage limit check involves checking a usage limit for a sender address or originating domain of the email.

7. The method according to claim 4, wherein the job rate limit check involves checking a job rate limit that specifies a number of messages that can be submitted by a domain, a single user, or a single user in a domain in a timeframe.

8. A system for anti-fraud message inspection, the system comprising:
a processor;
a non-transitory computer-readable medium; and
instructions stored on the non-transitory computer-readable medium and translatable by the processor for:
receiving an email that has passed a filtering mechanism at ingress of an enterprise computer network,
performing, utilizing local database files, a plurality of checks on the email, the local database files stored in a database;
responsive to the email failing any of the plurality of checks, placing the email in a suspect queue; and
responsive to the email passing the plurality of checks, placing the email in an application processing queue.

9. The system of claim 8, wherein the filtering mechanism comprises a fraud detection filter, a spam detection filter, or virus scanning software running on a networking device and wherein the networking device comprises at least one of a firewall, router, gateway, access point, or switch.

10. The system of claim 8, wherein the local database files comprise at least two of a Sender Policy Framework (SPF) rule, a blacklist, a whitelist, a destination file, a country code limit configuration file, a usage limit configuration file, or a job rate limit configuration file.

11. The system of claim 8, wherein the plurality of checks comprises at least two of an Internet Protocol (IP) check, a Sender Policy Framework (SPF) failure check, a destination check, a volume check, a country code limit check, a usage limit check, or a job rate limit check.

12. The system of claim 11, wherein the country code limit check involves checking a country code limit associated with the email.

13. The system of claim 11, wherein the usage limit check involves checking a usage limit for a sender address or originating domain of the email.

14. The system of claim 11, wherein the job rate limit check involves checking a job rate limit that specifies a number of messages that can be submitted by a domain, a single user, or a single user in a domain in a timeframe.

15. A computer program product for anti-fraud message inspection, the computer program product comprising a non-transitory computer-readable medium storing instructions translatable by a processor for:
receiving an email that has passed a filtering mechanism at ingress of an enterprise computer network,
performing, utilizing local database files, a plurality of checks on the email, the local database files stored in a database;
responsive to the email failing any of the plurality of checks, placing the email in a suspect queue; and
responsive to the email passing the plurality of checks, placing the email in an application processing queue.

16. The computer program product of claim 15, wherein the filtering mechanism comprises a fraud detection filter, a spam detection filter, or virus scanning software running on a networking device and wherein the networking device comprises at least one of a firewall, router, gateway, access point, or switch.

17. The computer program product of claim 15, wherein the local database files comprise at least two of a Sender Policy Framework (SPF) rule, a blacklist, a whitelist, a destination file, a country code limit configuration file, a usage limit configuration file, or a job rate limit configuration file.

18. The computer program product of claim 15, wherein the plurality of checks comprises at least two of an Internet Protocol (IP) check, a Sender Policy Framework (SPF) failure check, a destination check, a volume check, a country code limit check, a usage limit check, or a job rate limit check.

19. The computer program product of claim 15, wherein the country code limit check involves checking a country code limit associated with the email.

20. The computer program product of claim 15, wherein the usage limit check involves checking a usage limit for a sender address or originating domain of the email and wherein the job rate limit check involves checking a job rate limit that specifies a number of messages that can be submitted by a domain, a single user, or a single user in a domain in a timeframe.
